(19) United States
(12) Patent Application Publication
(10) Pub. No.: US 2016/0034602 A1
(43) Pub. Date: Feb. 4, 2016

(54) STORING AND PRESENTING DATA ASSOCIATING INFORMATION IN A FILE WITH THE SOURCE OF THE INFORMATION

(71) Applicant: Lenovo (Singapore) Pte. Ltd., New Tech Park (SG)

(72) Inventors: Arnold S. Weksler, Raleigh, NC (US); Rod David Waltermann, Rougemont, NC (US); Antonio Bumarch, III, Cary, NC (US); Neal Robert Caliendo, JR., Raleigh, NC (US)

(21) Appl. No.: 14/449,411

(22) Filed: Aug. 1, 2014

(51) Int. Cl. G06F 17/30

(52) U.S. Cl. CPC G06F 17/30997; G06F 17/30864; G06F 17/30581

(57) ABSTRACT

In one aspect, a device includes a processor and a memory accessible to the processor which bears instructions executable by the processor to identify data pertaining to a first file in response to an event at the first file, manipulate a second file based at least in part on the event at the first file, and in response to the manipulation, store the data pertaining to the first file in a storage area and associate in the storage area the data with the second file.

### FIELD

The present application relates generally to storing and presenting data associating information in a file with the source of information.

### BACKGROUND

There are instances where pieces of data from e.g. many various files or documents are placed in another single file or document. In such instances, there are times when a user may wish to determine certain specific information about a particular piece of data placed in the other document and/or previous actions involving the specific piece of data. There are currently no adequate, easy, and/or fast ways of determining such information.

### SUMMARY

Accordingly, in one aspect a device includes a processor and a memory accessible to the processor which bears instructions executable by the processor to identify data pertaining to a first file in response to an event at the first file, manipulate a second file based at least in part on the event at the first file, and in response to the manipulation, store the data pertaining to the first file in a storage area and associate in the storage area the data with the second file.

In another aspect, a method includes identifying an event at a first file, identifying data pertaining to the event and a source of the first file, and storing the data in a storage area and associating in the storage area the data with the source.

In still another aspect, a computer readable storage medium that is not a carrier wave comprises instructions executable by a processor to present a first file on a display of an information handling device, receive a request at the information handling device for a source of at least a portion of information contained in the first file, access a repository storing correlations of information in files with respective sources of the information in the respective files, and present information related to the source of the at least portion of the information contained in the first file.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIGS. 3 and 4 are flow charts showing example algorithms in accordance with present principles;

FIGS. 5 and 6 are example data structures in accordance with present principles; and

FIGS. 7-9 are example user interfaces (UIs) in accordance with present principles.

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g. smart TVs, Internet-enabled TVs), computers such as desktops, laptops and tablet computers, so-called convertible devices (e.g. having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

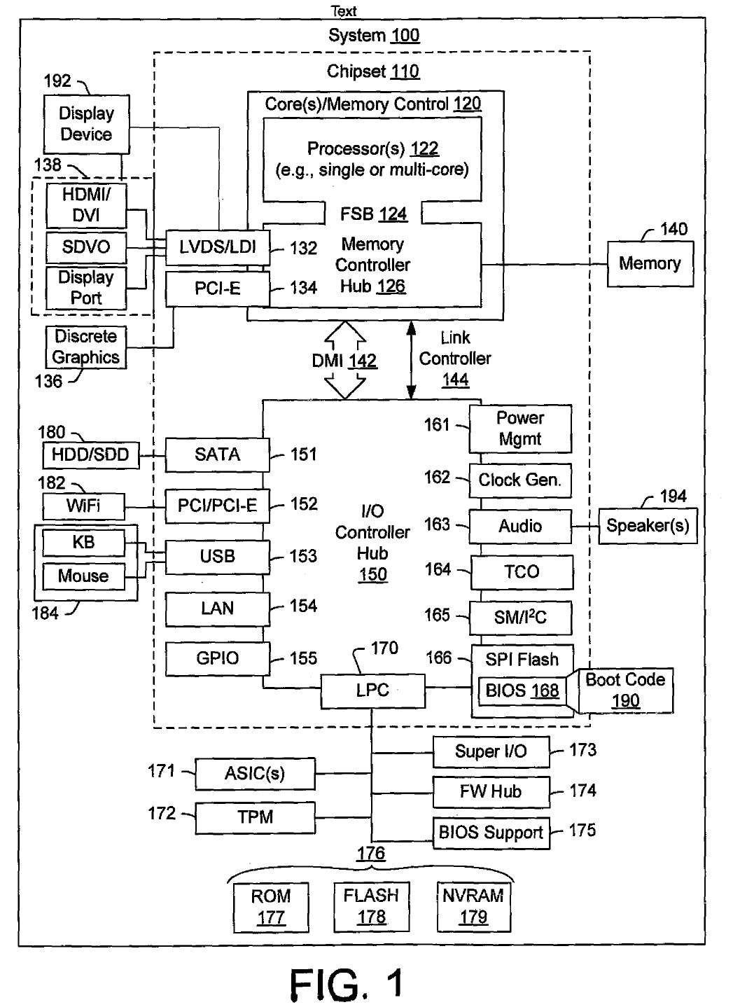

Now specifically in reference to FIG. 1, it shows an example block diagram of an information handling system and/or computer system 100. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be e.g. a game console such as XBOX® or Playstation®.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including e.g. one of more GPUs). An example system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though now shown for clarity, in some embodiments the system 100 may include a gyroscope for e.g. sensing and/or measuring the orientation of the system 100, an accelerometer for e.g. sensing acceleration and/or movement of the system 100, an audio receiver/microphone in communication with the processor 122 and providing input thereto based on e.g. a user providing audible input to the microphone, and a camera which is in communication with and provides input to the processor 122. The camera may be, e.g., a thermal imaging camera, a digital camera such as a webcam, and/or a camera integrated into the system 100 and controllable by the processor 122 to gather pictures/images and/or video. Still further, and also not shown for clarity, the system 100 may include a GPS transceiver that is configured to e.g. receive geographic position information from at least one satellite and provide the information to the processor 122. However, it is to be understood that another suitable position receiver other than a GPS receiver may be used in accordance with present principles to e.g. determine the location of the system 100.

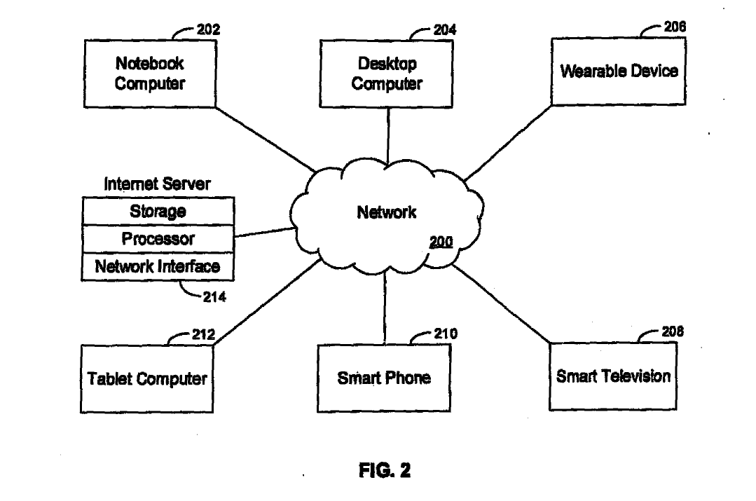

Before moving on to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as e.g. the Internet in accordance with present principles. It is to be understood that e.g. each of the devices described in reference to FIG. 2 may include at least some of the features, components, and/or elements of the system 100 described above. In any case, FIG. 2 shows a notebook computer 202, a desktop computer 204, a wearable device 206 such as e.g. a smart watch, a smart television (TV) 208, a smart phone 210, a tablet computer 212, and a server 214 in accordance with present principles such as e.g. an Internet server that may e.g. provide cloud storage accessible to the devices 202-212. It is to be understood that the devices 202-214 are configured to communicate with each other over the network 200 to undertake present principles.

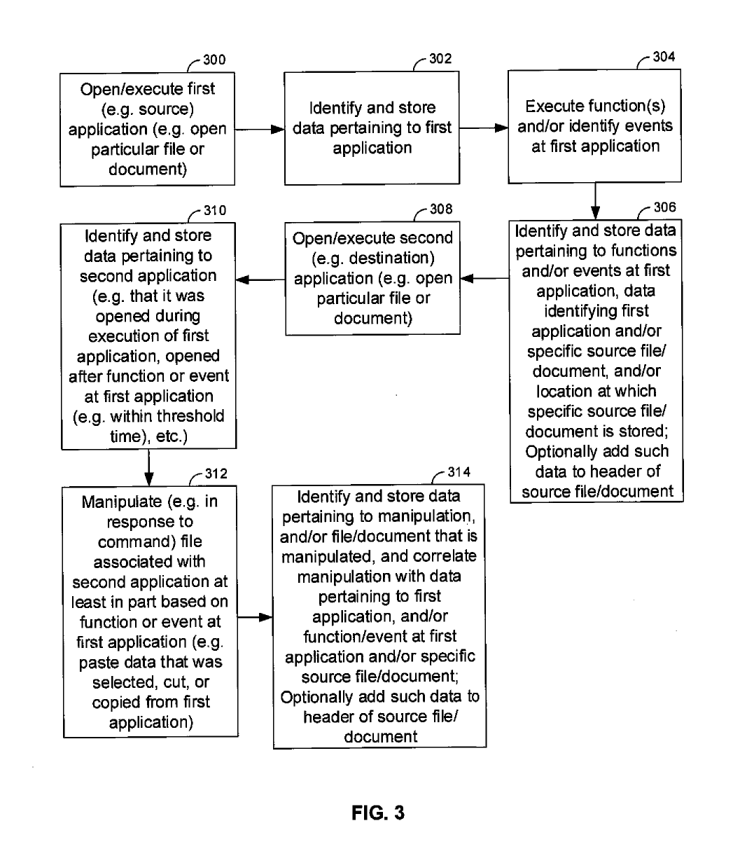

Referring to FIG. 3, it shows example logic that may be undertaken by a device such as the system 100 in accordance with present principles. Beginning at block 300, the logic opens and/or executes a first application (e.g. sometimes referred to below as a “source application”). The logic may open and/or execute the first application e.g. in response to a command to open a particular file or document (e.g. sometimes referred to below as a “source file”) associated with the first application. In any case, after doing so the logic proceeds from block 300 to block 302 where the logic identifies and stores (e.g. in a data storage area such as a repository to be discussed further below) data pertaining to the first application and/or the opening of the source file, such as e.g. the date and time the source file was opened, from which device of e.g. a plurality of devices, which user opened the source file and/or from which user profile it was opened, a physical location on the Earth at which the source file was opened (e.g. at the user's office, the user's home, in Morrisville, N.C., etc.) etc.

From block 302 the logic proceeds to block 304 where the logic executes one or more functions and/or identifies one or more events occurring at the first application and even e.g. the source file specifically. From block 304 the logic moves to block 306.

At block 306 the logic identifies and stores data pertaining to the functions and/or events at the first application. E.g., if a cut or copy command was executed at the source file, the command and/or data (e.g. metadata) related thereto is identified and stored (e.g. the data that was copied, the date and time of the copy, that the command was a copy command, and any tags such as e.g. user-generated metadata tags), and even e.g. the user and/or a user identity (e.g. user profile) for a user that issued the command as well as from where the command was issued (e.g. a physical location and/or a particular device (e.g. with a device ID or assigned a unique name)) is identified and stored. Still at block 306, the logic may identify and store still other data as disclosed herein such as e.g. data pertaining to the source application and/or the source file (e.g. source file and source application names and/or identification numbers, storage locations storing them, etc.).

Also at block 306, the logic may optionally add some or all of the data identified and/or stored at block 306 to a portion of the source file itself, such as e.g. to the header and/or tail of the source file, and/or interleaving it with other (e.g. payload) data. Further, updating metadata in the source file may include updating exchangeable image file format (EXIF) for pictures, and/or updating ID3 data in a MP3 files.

Still in reference to FIG. 3, after block 306 the logic proceeds to block 308, where the logic opens and/or executes a second application (e.g. sometimes referred to below as a “destination application”). The logic may open and/or execute the second application e.g. in response to a command to open a particular file or document (e.g. sometimes referred to below as a “destination file”) associated with the second application. In any case, after doing so at block 308 the logic proceeds from block 308 to block 310 where the logic identifies and stores (e.g. in a data storage area such as a repository to be discussed further below) data pertaining to the second application and/or the opening of the destination file, such as e.g. the date and time the destination file was opened, from which device of e.g. a plurality of devices, from which physical location, and/or which user did so. The data identified and stored at block 310 pertaining to the second application may also include data such as e.g. that the second application was opened during execution of another application such as the first application, that it was opened after a function or event at the first application (e.g. if within a threshold time from the occurrence of the function or event at the first application), etc.

After block 310, the logic proceeds to block 312 where the logic manipulates the destination file (e.g. in response to a command from a user to do so) at least in part based on a function or event at the first application and/or source file. For example, if a copy command was executed at the source file to copy particular data, at block 312 and responsive to a paste command to the destination file the logic may paste the particular data that was copied from the source file.

From block 312 the logic proceeds to block 314 where the logic identifies and stores data pertaining to the manipulation of the destination file (e.g. the user that manipulated it and from which physical location), and/or identifies and stores data pertaining to the destination file itself. The logic at block 314 also correlates data identified and stored thereat (e.g. data identifying the manipulation) with data pertaining to the first application (e.g. the most-recent time it was opened prior to opening the second application), as well as e.g. the source document itself, the function and/or event at the source document, the data acted upon based on the function or event at the source document and the date and time of action, etc.

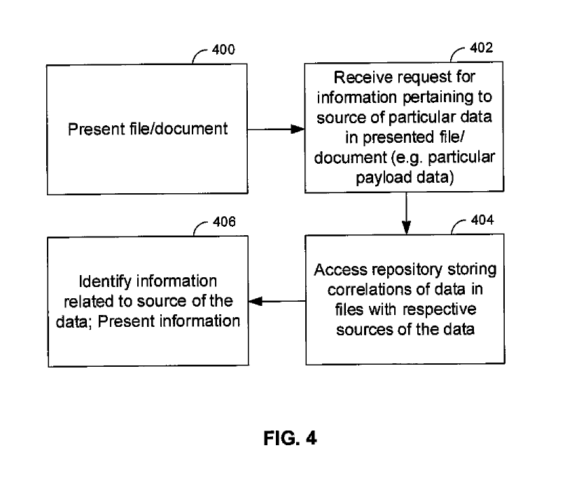

Now in reference to FIG. 4, it also shows example logic that may be undertaken by a device such as the system 100 in accordance with present principles. Beginning at block 400, the logic presents on the device a file and/or document, such as e.g. a destination document. The logic then proceeds to block 402 where the logic receives a request (e.g. from a user controlling the device) for information pertaining to the source of particular data (e.g. an object such as an image or another portion of payload data in the destination file) in the destination file.

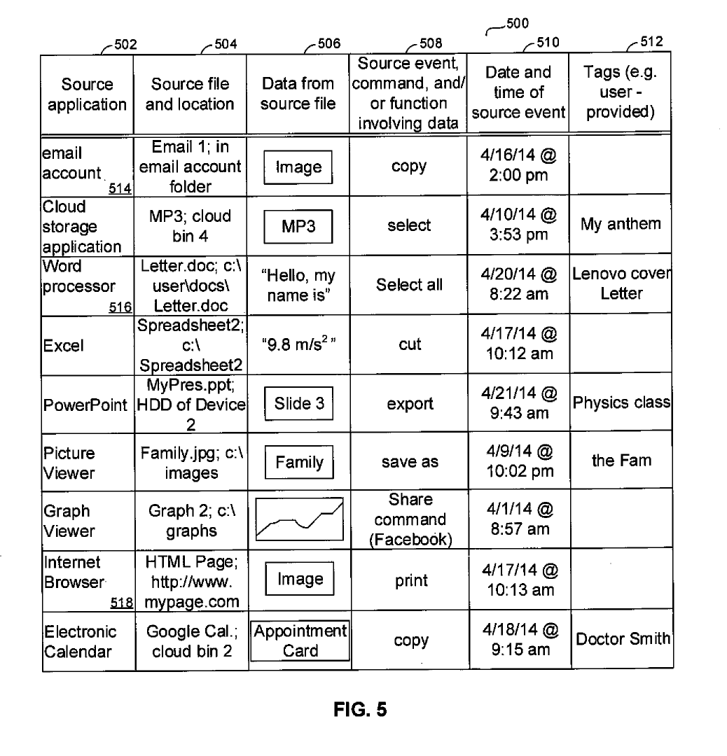

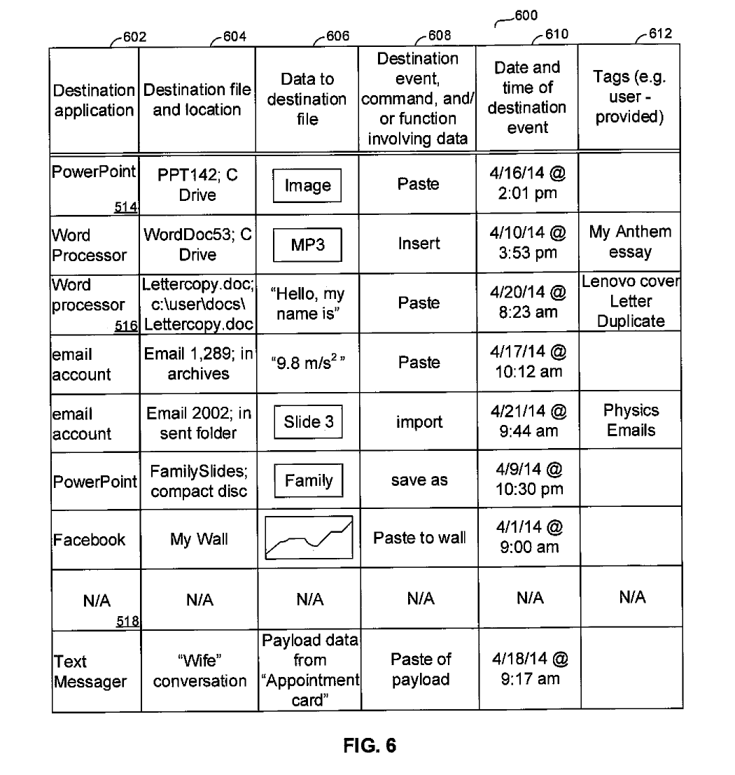

Responsive to the request received at block 402, the logic proceeds to block 404 where the logic accesses a data repository storing source and destination data in accordance with present principles, such as e.g. correlations between data in destination files with respective sources (e.g. source files or source applications) of the data. Example data structures for a repository will be discussed in reference to FIGS. 5 and 6. Regardless, once the repository is accessed, information related to a source of data to which the request pertains is identified therefrom and presented on the device (e.g. in a format such as the example one discussed in reference to FIG. 9).

Now in cross-reference to FIGS. 5 and 6, they show example data structures (e.g. data tables) that may be created, filled, and/or established based on data as described herein that is identified, determined, and/or collected. It is to be understood that the structure 500 of FIG. 5 and structure 600 of FIG. 6 may in some embodiments in fact be a single structure (e.g. with the structure 600 being disposed on such a unitary structure to the right of the last column of the structure 500) and that the structures 500 and 600 have been shown in different figures for clarity.

In any case, the structure 500 of FIG. 5 shows various columns for data related to “sources” at which actions, events, commands, functions, manipulations, etc. (referred to below as “source events” for simplicity) occurred, and each row of the structure 500 corresponds to a given source event. E.g., a first column 502 is related to a source application at which a source event occurred, a second column 504 is related to a source file and/or location (e.g. file path, hard disk drive, parent file, etc.) at which the source event occurred, a third column 506 is related to data at the source file to which the source event pertains (e.g. data that was copied), a column 508 is related to description and/or indication of the particular type or class of source event, a column 510 is related to a date and time of the source event, and a column 512 contains tags related to the source event such as e.g. user-generated tags

The structure 600 of FIG. 6 shows various columns for data related to “destinations” at which actions, events, commands, functions, manipulations, etc. (referred to below as “destination events” for simplicity) occurred, and each row of the structure 600 corresponds to a given destination event. E.g., a first column 602 is related to a destination application at which a destination event occurred, a second column 604 is related to a destination file and/or location (e.g. file path, hard disk drive, parent file, etc.) at which the destination event occurred, a third column 606 is related to data at the destination file to which the destination event pertains (e.g. data that was pasted), a column 608 is related to description and/or indication of the particular type or class of destination event, a column 610 id related to a date and time of the destination event, and a column 612 contains tags related to the destination event such as e.g. user-generated tags.

Thus, describing a few rows as examples and still in joint reference to FIGS. 5 and 6, a row 514 pertains to a source event occurring at an email source application involving a particular email titled “Email 1” that is located in an email account folder of the associated email account. The data pertaining to the source event to which row 514 pertains is an image (it being understood that e.g. in some embodiments the image itself may be stored in the structure such that it is stored in the box where row 514 and column 506 intersect). The source event was a copy command, and the event occurred on Apr. 16, 2014 at 2:00 p.m. The destination event associated with the image from Email 1 occurred at a slide presentation application and in particular a slide presentation file titled “PPT 142” that is located (e.g. stored) generally in the “C” drive of a device. The column 606 entry corresponding to row 514 may contain the image even if in some embodiments it is also stored at e.g. column 506, row 514. In any case, as may be appreciated from the structure 600, the destination event corresponding to row 514 was a paste event that occurred on Apr. 16, 2014 at 2:01 p.m. No tags have been associated with the entry, event, and/or image itself.

As another example, row 516 pertains to a source event occurring at a word processor source application involving a document titled “Letter” that is located at a file path for the C drive that is c\user\docs\Letter.doc. The data pertaining to the source event to which row 516 pertains is text at least including the words “Hello, my name is” (it being understood that e.g. in some embodiments the text itself may be stored in the structure such that it is stored in the box where row 516 and column 506 intersect). The source event was a select all command, and the event occurred on Apr. 20, 2014 at 8:22 a.m. The destination event associated with the text from Letter.doc occurred at a word processor application and in particular a document titled “LetterCopy” that is located (e.g. stored) at file path c:\user\docs\LetterCopy.doc. The column 606 entry corresponding to row 516 may contain the text even if in some embodiments the text is also stored at e.g. column 506, row 516. The destination event corresponding to row 516 was a paste event that occurred on Apr. 20, 2014 at 8:23 a.m. Discussing the tag entries of columns 512 and 612 for row 516, in contrast to the tag entry for row 516 at column 512 which indicates the tag for the e.g. source event, source document, and/or source text being “Lenovo Cover Letter,” the tag for the e.g. destination event, destination document, and/or destination text at row 516, column 612 is “Lenovo Cover Letter Duplicate.”

As but one more example, row 518 pertains to a source event occurring at an Internet browser source application involving an HTML page that is located at http://www.mypage.com. The data pertaining to the source event to which row 518 pertains is an image. The source event was a print command, and the event occurred on Apr. 17, 2014 at 10:13 a.m. There have been no tags associated with the source event. Also note that the entries for columns 602-612 for row 518 do not contain any data associated with a destination event since, in this example, there was no destination event involving the data (image) from the HTML page that was printed.

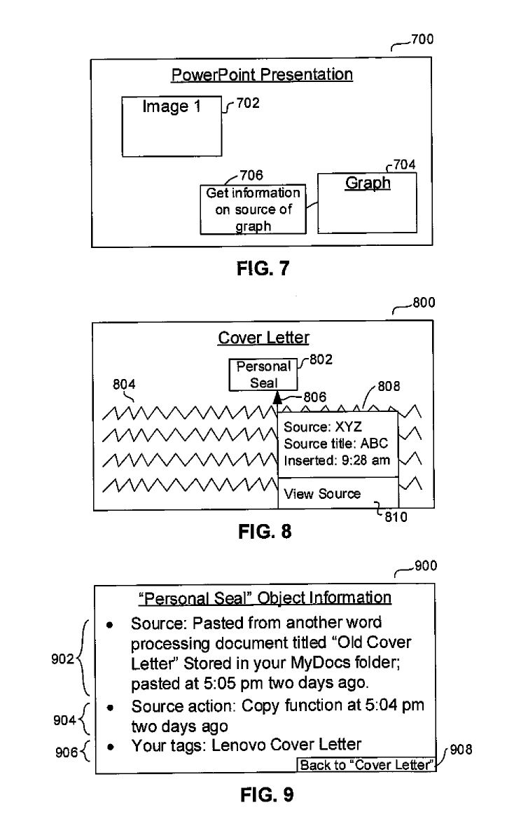

Before moving on to the description of FIG. 7, it is to be understood that one or both of the example data structures 500 and 600 may include still other columns for respective information pertaining to a given event, such as a column for e.g. a user and/or user identity (e.g. user profile) involved in and/or causing the event to occur (e.g. issuing a command), as well as a column for the location of the event such as e.g. the physical location (e.g. city, state, type of building, user-generated location ID tag associated with e.g. an IP address) and/or the device at which the event occurred.

Continuing the detailed description now in reference to FIG. 7, it shows an example user interface (UI) that may be presented on a device such as the system 100. The UI 700 is understood to be presented based on execution of a slide presentation application, and in the example shown includes an image 702 and a graph 704. It is to be understood that e.g. a right-click selection of the graph 704 has been made (it being understood that e.g. a left-click or other selection method may be used in some embodiments), which in response thereto has caused the device to present pop-up and/or overlay selector element 706 to be presented. It is to be understood that selection of the selector element 706 (which contains text prompting a user that selection of the element 706 will cause information on the source of the graph to be presented) is selectable to automatically without further user input responsive thereto e.g. cause the device presenting the UI 700 to access a data structure such as the structures 500 and 600 described above to identify information pertaining to the source of the graph and present at least some of the information that is identified on the device. Such a presentation of information will be described below in reference to FIG. 9.

However, before describing FIG. 9, another example UI 800 is shown in FIG. 8. The UI 800 is understood to be presented on a display based on execution of a word processor application to present a particular word processing document tilted “Cover Letter” as shown, and in the example shown the Cover Letter includes an personal seal 802 above text 804. Note that a cursor 806 is shown that is e.g. controllable from a touch pad of the device presenting the UI 800 and/or from a mouse. The cursor 806 is understood to be hovering over but not necessarily “selecting” (e.g. via a click of a mouse) the seal 802. Nonetheless, detection of the hover automatically without further user input may cause the device presenting the UI 800 to access a data structure such as the structures 500 and 600 described above to identify information pertaining to the source of the seal and present at least some of the information that is identified in a pop-up and/or overlay box 808 such that it e.g. overlays on top of at least part of the text 804. As shown, the box 808 includes information indicating the source application for the seal (e.g. application “XYZ”) as well as the source file title (e.g. “ABC”) and the time that the destination event resulting in the seal 802 being included in the document Cover Letter occurred (e.g. 9:28 a.m.). Also note that a selector element 810 is shown which is selectable to automatically without further user input responsive thereto cause the device presenting the UI 800 to present the source document ABC on the device. Though not shown, it is to be understood that the box 808 may also include a more information selector element which may be selectable to automatically without further user input responsive thereto cause a more detailed presentation of source and/or destination information to be presented, such as e.g. the UI 900 to be described shortly in reference to FIG. 9.

Now in reference to the aforementioned UI 900 of FIG. 9, it may include information and/or representations of some or all data in a data structure pertaining to e.g. a source and a destination (and/or specifically a source event and a destination event), such as e.g. all the information in a given row of the structures 500 and 600. It is to be understood that FIG. 9 continues with the personal seal example from FIG. 8. Thus, the UI 900 includes source information 902 indicating that the seal was pasted from another word processing document titled “Old Cover Letter” that is stored in the user and/or device's “MyDocs” folder, and that the seal was pasted into Cover Letter at 5:05 p.m. two days ago. The UI 900 also includes source event and/or action information 904, which in the present instance indicates that the source action at Old Cover Letter was a copy function that occurred at 5:04 p.m. two days ago. Furthermore, the UI 900 includes tag information 906 indicating tags for the document Old Cover Letter that e.g. are searchable using a search feature for the device. In the example shown, the tag is “Lenovo Cover Letter.”

Still in reference to FIG. 9, note that it also shows a selector element 908 that is selectable to automatically without further user input responsive thereto cause a previously presented file to be presented and e.g. specifically the file previously presented from which the UI 900 was invoked (which in this case may be the UI 800 and/or the document Cover Letter).

Without reference to any particular figure, it is to be understood that a source file in accordance with present principles need not necessarily be e.g. the first “source” of the file but rather in some embodiments may be e.g. the source where the first file was first accessed by a device undertaking present principles. E.g. if an email attachment was downloaded from an email to the desktop of a device and then opened, the “source” may not be a different device that actually sent the file to the email account but instead may be e.g. the email account which received the file and/or the desktop location to which the file was downloaded from the email account.

Additionally, it is to be understood that in some embodiments in addition to or in lieu of presenting information related to an event and/or file in a visual format e.g. such as is shown on the UI 900, such information may be audibly presented to a user e.g. using a speaker on the device.

Furthermore, it is to be understood that the data structures and/or databases described herein are examples, and that present principles recognize that there are other ways to implement a data structure and/or database to store and associate the data described herein. E.g., a distributed file/database format may be used where the data may be, for example, broken out in to a file-per-database table, in which case the data on the first file (e.g. source file) may be associated and stored in a plethora of files and/or (e.g. disparate) locations.

Also without reference to any particular figure, it is to be understood in accordance with present principles that by e.g. opening or closing a document, receiving an email, performing a function at a file such as a cut or paste, etc., metadata may be collected automatically in response thereto and stored in a data structure. Furthermore, e.g. upon an insertion of such data from one file to a second file (e.g. or even a social networking account area such as e.g. a profile or status update), if at a later time a user wishes to determine where the data as appearing in the second file originated from, the user may do so as set forth herein and can even further easily locate the original document from which the data came. Furthermore, present principles recognize that a user may e.g. via a UI presented automatically responsive to e.g. a cut or copy command create a tag or key word to be included with such metadata and even the source file (e.g. in the header and/or tail) itself for easy location of the source file at a later time based on a search for the tag or keyword.

Also, it is to be understood that e.g. should a source location be in cloud storage, a universal resource indicator (URI) may form part of the metadata indicating the source location.

It may now be appreciated that present principles provide for indexing of information such as e.g. a picture, chart, slide, text, or other content so that its source may be easily located regardless of its location and without a user e.g. needlessly searching multiple locations based on hunches and guesses as to where the information may have been from. Thus, present principles provide for the tagging of both e.g. the source itself with meta-data and as well as storing such metadata in a repository, where the metadata pertains to things such as e.g. copy and paste events and document destination tagging information. The repository may also store objects from the payload of the source as well (such as e.g. images and music files) that are e.g. uniquely identifiable to allow for correlations and pedigree tracking between source and destinations to allow for querying at a later date or time (e.g. querying the repository and/or querying files (e.g. headers and/or tails)). For example, if a device is presenting a presentation file including a graph, and a user wishes to find the original source spreadsheet with data points from which the graph was created, the original spreadsheet that may be contained in an email document, calendar attachment, cloud storage, or other devices that is easily identifiable in accordance with present principles to determine e.g. where the data points pasted into the graph came from.

Before concluding, it is to be understood that although e.g. a software application for undertaking present principles may be vended with a device such as the system 100, present principles apply in instances where such an application is e.g. downloaded from a server to a device over a network such as the Internet. Furthermore, present principles apply in instances where e.g. such an application is included on a computer readable storage medium that is being vended and/or provided, where the computer readable storage medium is not a carrier wave and/or a signal per se.

While the particular STORING AND PRESENTING DATA ASSOCIATING INFORMATION IN A FILE WITH THE SOURCE OF THE INFORMATION is herein shown and described in detail, it is to be understood that the subject matter which is encompassed by the present application is limited only by the claims.

What is claimed is:

1. A first device, comprising:
a processor; and
a memory accessible to the processor and bearing instructions executable by the processor to:
identify data pertaining to a first file in response to an event at the first file;
manipulate a second file based at least in part on the event at the first file; and
in response to the manipulation, store the data pertaining to the first file in a storage area and associate in the storage area the data with the second file.

2. The first device of claim 1, further comprising a display accessible to the processor; wherein the data is first data, and wherein the instructions are further executable to:
at the second file, receive a request for information pertaining to second data associated with the manipulation; and
in response to the request, present on the display information pertaining to the second data, the information identified at least based in part on accessing the first data in the storage area.

3. The first device of claim 2, wherein the second data forms at least a portion of the payload of the second file.

4. The first device of claim 1, wherein the data comprises information pertaining to the event.

5. The first device of claim 1, wherein the data comprises information regarding the source of the first file, wherein the source is where the first file was first accessed by the first device.

6. The first device of claim 1, wherein the data comprises information pertaining to a location at which the first file is stored.

7. The first device of claim 1, wherein the data is associated with the second file to correlate the manipulation with the event at the first file.

8. The first device of claim 1, wherein the data comprises information pertaining to an application selected from the group consisting of: an application used to undertake the event, an application through which the first file was accessed when the event occurred.

9. The first device of claim 1, wherein the data is metadata.

10. The first device of claim 1, wherein the instructions are further executable to:
add metadata to the first file pertaining to at least one of the event, the second file, the manipulation, a location in the storage area at which the data is stored, the source of the first file, an application used to undertake the event, and an application through which the first file was accessed when the event occurred.

11. The first device of claim 10, wherein the metadata is added to a header portion of the first file.

12. The first device of claim 1, wherein the event is selected from the group consisting of: performance of a select command, performance of a select all command, performance of a copy command, performance of a cut command, performance of an export command, performance of a save command, performance of a share command, performance of a print command.

13. The first device of claim 1, wherein the manipulation is selected from the group consisting of: performance of a paste command on the second file, performance of an import command on the second file, performance of a share command on the second file.

14. A method, comprising:
identifying an event at a first file;
identifying data pertaining to the event and a source of the first file; and
storing the data in a storage area and associating in the storage area the data with the source.

15. The method of claim 14, wherein the data is first data, and wherein the method further comprises:
receiving a command to perform a function at a second file using second data from a payload of the first file;
performing the function; and
in response to performing the function, adding to the first data in the storage area third data pertaining to performance of the function.

16. The method of claim 14, wherein the source is selected from the group consisting of: an email, an email account, a word processing document, a spreadsheet, an image, a graph, a web page, an electronic calendar, a cloud storage area, a device different from the first device.

17. The method of claim 14, wherein:
the event is selected from the group consisting of: a cut function, a copy function, a selection of payload data; and
the data further comprises information pertaining to an application selected from the group consisting of: an application used to undertake the event, an application through which the first file was accessed when the event occurred.

18. A computer readable storage medium that is not a carrier wave, the computer readable storage medium comprising instructions executable by a processor to:
present a first file on a display of an information handling device;
receive a request at the information handling device for a source of at least a portion of information contained in the first file;
access a repository storing correlations of information in files with respective sources of the information in the respective files; and
present information related to the source of the at least portion of the information contained in the first file.

19. The computer readable storage medium of claim 18, wherein the correlations further correlate the respective information in the respective files with respective events that occurred on the respective information at the respective sources.

20. The computer readable storage medium of claim 18, wherein the request pertains to a source of only the portion of information and not a source of all information in the first file.
